(19) United States
(12) Patent Application Publication
(10) Pub. No.: US 2006/0029024 A1
(43) Pub. Date: Feb. 9, 2006

(54) System and method for battery conservation in wireless stations

(76) Inventors: Guang Zeng, Selden, NY (US); Huayan Amy Wang, Hauppauge, NY (US)

Correspondence Address: FAY KAPLUN & MARCIN, LLP, Suite 702, 150 Broadway, New York, NY, 10038, US

(21) Appl. No.: 11/042,883

(22) Filed: Jan. 25, 2005

Related U.S. Application Data
(60) Provisional application No. 60/599,142, filed on Aug. 5, 2004.

(51) Int. Cl. H04B 7/216

(52) U.S. Cl. 370/335

(57) ABSTRACT

Described are a system and method for battery conservation in a wireless station. Initially, a wireless station switches, according to a predetermined time schedule, from a first communications mode into a second communications mode. The station is capable of at least one of receiving and transmitting data packets only when the station is in the second communications mode. The first mode is a power conservation mode. When the station is in the second mode, a wireless access point obtains a priority access to a radio channel. Then, the access point reserves the radio channel for wireless communications between the access point and the station. Wireless communications are conducted between the access point and the station over the radio channel. Upon a termination condition, the station switches into the first mode.

### PRIORITY CLAIM

This application claims the benefit of U.S. Provisional Patent Application Ser. No. 60/599,142 filed Aug. 5, 2004, entitled “Automatic Power-Save Delivery in 802.11e Networks.” The entire disclosure of this prior application is considered part of the disclosure of the accompanying application and is hereby expressly incorporated by reference herein.

### BACKGROUND

Many wireless stations (“STAs”) (e.g., cell phones, PDAs, scanners, laptops, hand-held PCs, etc.) are capable of wireless connection to a computer network, such as the Internet, a local network, a corporate network and others. As a result, these STAs do not require any wired connections to carry out their functions. Batteries are commonly used to power the STAs described herein, since they provide complete freedom of movement to the users thereof. Alternatively, power adapters may be used to power the STAs using electrical sockets. However, this approach requires tethering the STAs to a stationary power supply with cords, which reduces portability and usefulness. Thus, maintaining mobility and reducing power consumption are predominant concerns of users and manufacturers of the STAs.

The STAs typically utilize a known communication protocol (e.g., IEEE 802.11 standard) when wirelessly communicating with an access point (“AP”) which is connected to the network. Realizing that power consumption and battery life are important to users and manufacturers of the STAs, the 802.11 standard includes power-saving mechanisms. According to these mechanisms, data packets that are intended for the STAs are buffered at the AP while the STAs are in a sleep mode (i.e., power-save mode). Upon waking from sleep mode, the AP transmits the buffered data packets to the STAs. Thus, the STAs do not have to be in a perpetual wake mode (i.e., consuming battery power) to receive the data packets.

In anticipation of real-time applications (e.g., VoIP, video streaming, etc.) with Quality of Service (“QoS”) requirements, an 802.11e standard was developed to support these applications. The QoS requirements reflect the ability of STAs and APs to provide some level of assurance for consistent data packet delivery. The 802.11e standard further provides a power save mechanism through an automatic power-save delivery (“APSD”). Two types of service periods are possible using the APSD: unscheduled and scheduled. Unscheduled service periods are defined only for QoS-enhanced wireless stations (“QSTAs”) accessing the channel using an enhanced distributed channel access (“EDCA”). Scheduled service periods are defined for QSTAs using the EDCA or an hybrid coordination function (“HCF”) controlled channel access (“HCCA”). However, according to the 802.11e standard and for both scheduled and unscheduled service periods, the QSTA is in wake mode for a prolonged period, because it must contend for access to a radio channel, which serves as a medium for wireless transmissions. Although the APSD of the 802.11e standard is intended to reduce power consumption, requiring the AP and the QSTA to contend for access to the channel may have the side effects of increasing battery power consumption, causing delay jitter and/or increasing system overhead.

### SUMMARY OF THE INVENTION

A system and method according to the present invention for battery conservation in a wireless station. Initially, a wireless station switches, according to a predetermined time schedule, from a first communications mode into a second communications mode. The station is capable of at least one of receiving and transmitting data packets only when the station is in the second communications mode. The first mode is a power conservation mode. When the station is in the second mode, a wireless access point obtains a priority access to a radio channel. Then, the access point reserves the radio channel for wireless communications between the access point and the station. Wireless communications are conducted between the access point and the station over the radio channel. Upon a termination condition, the station switches into the first mode.

In a further exemplary embodiment, when a wireless station has a first data packet addressed for a wireless access point, the station switches from a first communications mode to a second communications mode. The station is capable of at least one of receiving and transmitting data packets only when the station is in the second communications mode. The first mode is a power conservation mode. When a radio channel is available to the station, the station transmits to the access point the first data packet by the station using the radio channel. The access point receives the first data packet. The access point transmits an ack packet to the station. The ack packet is indicative of receipt by the access point of the first data packet and one of (1) existence and (2) nonexistence of a second data packet addressed for the station. If one of (1) the ack packet indicates the existence of the second data packet and (2) the station has a further data packet addressed for the access point, the access point obtains a priority access to the radio channel. Then, the access point reserves the radio channel for wireless communications between the access point and the station. Wireless communications are conducted between the access point and the station over the radio channel. Upon a termination condition, the station switches into the first mode.

### BRIEF DESCRIPTION OF THE DRAWINGS

FIG. 1 shows an exemplary embodiment of a wireless network according to the present invention;

FIG. 2 shows a schematic representation of a conventional scheduled automatic power-save delivery (“APSD”) mechanism;

FIG. 3 shows a schematic representation of an exemplary embodiment of an enhanced scheduled APSD mechanism according to the present invention;

FIG. 4 shows an exemplary embodiment a method for enhanced scheduled APSD according to the present invention;

FIG. 5 shows a schematic representation of a conventional unscheduled APSD mechanism;

FIG. 6 shows a schematic representation of an exemplary embodiment of an enhanced unscheduled APSD mechanism according to the present invention;

FIG. 7 shows a schematic representation of a further conventional unscheduled APSD mechanism;

FIG. 8 shows a schematic representation of a further exemplary embodiment of an enhanced unscheduled APSD mechanism according to the present invention; and

FIG. 9 shows an exemplary embodiment of a method for enhanced unscheduled APSD according to the present invention.

### DETAILED DESCRIPTION

The present invention may be further understood with reference to the following description and the appended drawings, wherein like elements are referred to with the same reference numerals. Embodiments of the present invention relate to improvements in power-saving mechanisms for STAs (e.g., cell phones, PDAS, bar code scanners, laptops, hand-held PCs, etc.), and in particular, an automatic power-save delivery (“APSD”) mechanism utilized in an 802.11 standard (e.g. 802.11e). The improvements described herein may lower battery power consumption for the STA, reduce jitter for scheduled services and reduce protocol overhead for specific applications with defined characteristics (e.g., VoIP, video streaming, etc.).

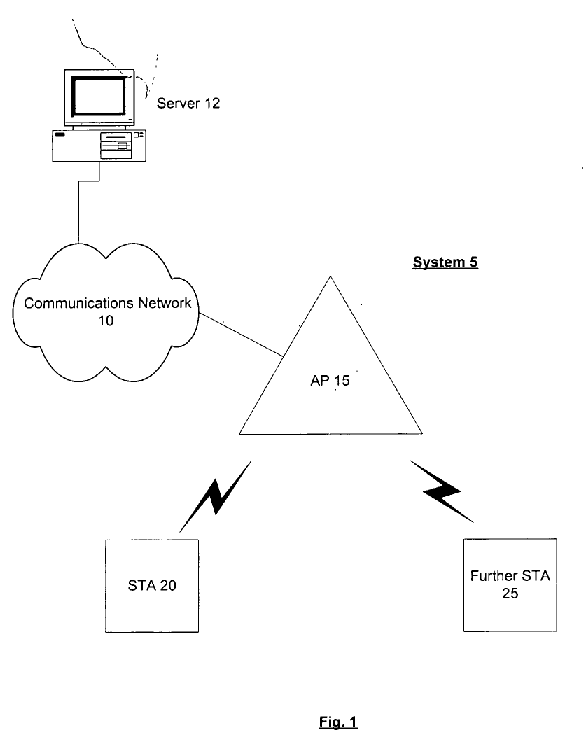

FIG. 1 shows an exemplary embodiment of a system 5 according to the present invention. The system 5 may include an access point (“AP”) 15 connected to a communications network 10. The communications network 10 may be connected to a server 12. The AP 15 may wirelessly communicate with any number of wireless stations (e.g., cell phones, PDAs, laptops, hand-held PCs, printers, headsets) which may utilize a wireless switch architecture. The present invention will be described with reference to the AP 15, a wireless station (“STA”) 20 and a further STA 25. As would be understood by those skilled in the art, the system 5 may include any number of APs and STAs.

The AP 15 and the STAs 20, 25 may operate according to a conventional wireless communication protocol such as, for example, an IEEE 802.11 standard. In a preferred embodiment, the IEEE 802.11 standard is the 802.11e standard which implements a quality of service (“QoS”) in 802.11 networks (i.e., wireless local area networks (“WLANs”)). As understood by those skilled in the art, the QoS modifies 802.11 access rules by allowing data with a higher priority to be given preferential access to a radio channel used by the network 10. Thus, high priority data (e.g., VoIP, streaming video, etc.) may be granted access to the channel over lower priority data (e.g., emails, webpages, etc.).

According to the present invention, the STA 20 may have a first communications mode (e.g., a “sleep” mode), in which the STA 20 is saving power (i.e., not transmitting/receiving data), and a second communications mode (e.g., a “wake” mode), in which it may be transmitting or receiving data, or preparing to do either. The STA 20 switches between the sleep mode and the wake mode, according to protocols for scheduled and unscheduled service periods. When the STA 20 is in the wake mode, it may receive data packets from and transmit data packets to the AP 15 and/or the further STA 25. However, while in the sleep mode, the data packets that would be transmitted from the AP 15 to the STA 20 if it were in the wake mode are buffered at the AP 15. Thus, when the service period begins, the STA 20 switches into wake mode and receives those buffered packets. However, conventional 802.11 access rules require that the STA 20 remains in the wake mode for a prolonged period of time to transmit and receive data packets, which contributes to system traffic and reduces efficiency of a battery used by the STA 20.

In an attempt to conserve the battery, the 802.11e standard defines a conventional automatic power-save delivery (“APSD”) mechanism, in which the AP 15 must wait to transmit the data packet to the STA 20 if the further STA 25 is transmitting data packets over the channel. Thus, the AP 15 will have to wait for a random amount of time (e.g., a “backoff”) and until the channel is idle before transmitting the data packet to the STA 20. This waiting time, in turn, causes the STA 20 to be in the wake mode for a prolonged period, thereby increasing its power consumption and potentially adding to system overhead (e.g., channel traffic).

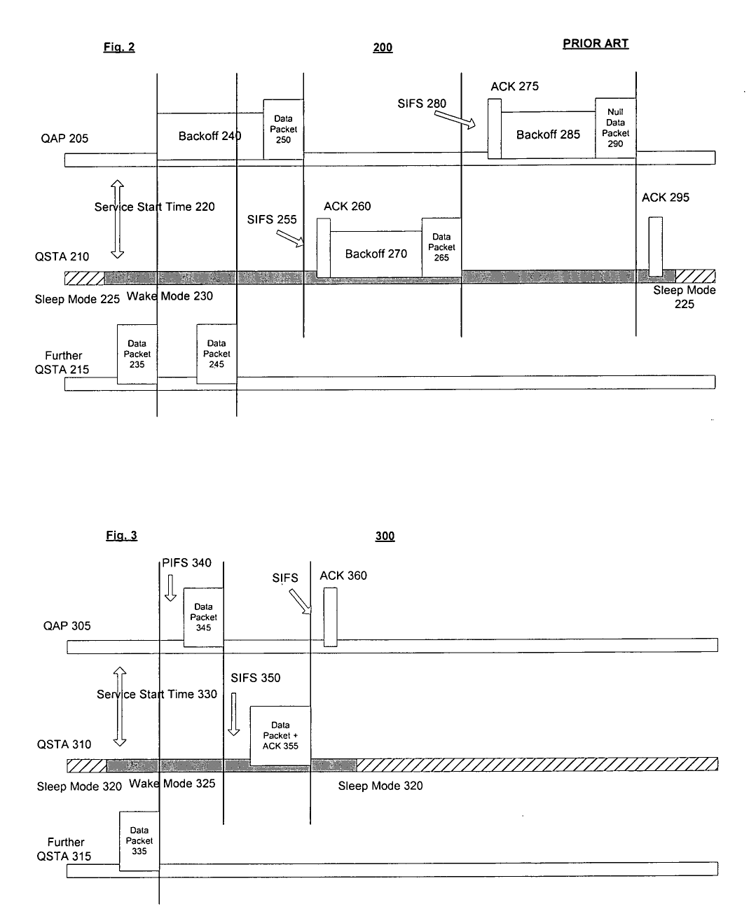

FIG. 2 shows a conventional scheduled APSD mechanism 200 using an enhanced distributed channel access (“EDCA”) mode. As is known in the art, the 802.11e standard defines a new coordination function, a hybrid coordination function (“HCF”), which is used in a QoS enhanced basic service set (“QBSS”). The HCF has two modes of operation, the EDCA mode and a HCF controlled channel access (“HCCA”) mode. The EDCA mode is a contention-based channel access function that operates during a contention period. The contention period is a portion (or all) of a time between beacons sent by the AP. During the contention period, wireless stations (e.g., STAs and APs) contend for channel access using a channel access mechanism (e.g., the EDCA mode, distributed coordination function (“DCF”), point coordination function (“PCF”), carrier sense multiple access with collision avoidance (“CSMA/CA”)).

When the contention period is not the full time between beacons, a remaining portion of the time between the beacons is a contention-free period. During the contention-free period, STAs are polled by a coordinator (e.g., point coordinator, hybrid coordinator) at the access point. While being polled, the STAs may communicate with the AP without having to contend for channel access. Thus, the EDCA mode may operate concurrently (e.g., between the same beacon period) with the HCCA mode. As known in the art, the EDCA mode and the HCCA mode enhance and extend the functionality of the original access methods, DCF and PCF.

As shown in FIG. 2, the conventional scheduled APSD mechanism 200, during the contention period, utilizes an AP 205, a STA 210 and a further STA 215. Though the present invention will be described with respect to operation during the contention period (e.g., using the EDCA mode), those of skill in the art would understand that aspects of the present invention may be applied to operation in the contention-free period (e.g., using the HCCA mode).

As understood by those skilled in the art, the AP 205 and the STA 210 may be QoS-enhanced, and will hereinafter be referred to as the QAP 205 and the QSTA 210. The further STA 215 may be QoS enhanced, as well. Though components of the mechanism 200 will be described with regard to the QoS according to the 802.11e standard, those of skill in the art would understand that the present invention may be employed by networks which utilize further versions of the 802.11 standard (e.g., 802.11a, 802.11b, 802.11g, etc.).

According to the conventional scheduled APSD mechanism 200, a service period is initiated at a service start time (“SST”) 220. In the conventional scheduled APSD mechanism 200, the SST 220 is based on a predetermined agreement between the QAP 205 and the QSTA 210. The SST 220 represents that the QSTA 210 should switch from a sleep mode 225 to a wake mode 230. The SST 220 may occur, for example, in thirty millisecond intervals. As understood by those skilled in the art, the QSTA 210 may enter the wake mode 230 at the SST 220 or a predetermined time prior to the SST 220.

However, as shown in FIG. 2, at the SST 220, the channel is busy because the further QSTA 215, or any further STA, is transmitting a data packet 235 on the channel. Because the channel is busy, the QAP 205 may wait until the channel is idle. As understood by those skilled in the art, if the channel had been idle (i.e., no transmissions thereon) at the SST 220, the QAP 205 may not have to wait to transmit. However, after sensing that the channel is busy, the QAP 205 begins a backoff 240, in which a timer in the QAP 205 counts down from a random value. While counting down, the QAP 205 continually reassesses the channel, and when idle, the QAP 205 decrements the timer for each idle slot on the channel. As shown in FIG. 2, the backoff 240 may have a duration such that the further QSTA 215 or any other STA may transmit a second data packet 245 on the channel before the random value decrements to zero, because a timer of the further QSTA 215 or any STA reaches zero before the backoff 240 is concluded. While the QAP 205 is performing the backoff 240, the QSTA 210 remains in the wake mode 230. If the channel is very busy, the QSTA 210 may remain in the wake mode 230 for a prolonged period of time, all the while consuming battery power.

The QAP 205 may undergo further backoffs, increasing the random value for each, for as long as the channel remains busy. When the channel is idle, the QAP 205 transmits a buffered data packet 250 to the QSTA 210. Those of skill in the art would understand that the buffered data packet 250 may include one or more buffered data packets, as well as data packets that may have arrived during the service period.

As understood by those skilled in the art, the QSTA 210 may send an acknowledgment (“ACK”) 260 to the QAP 205 after waiting for a short interframe space (“SIFS”) 255 after receiving the data packet 250. If the QSTA 210 has a data packet 265 to transmit to the QAP 205 and the channel is again busy, the QSTA 210 must perform a backoff 270 before transmitting the data packet 265.

After the QSTA 210 transmits the data packet 265 to the QAP 205, the QSTA 210 waits for an ACK 275 from the QAP 205. A response from the QAP 205 is similar to that performed by the QSTA 210. After the QAP 205 transmits the ACK 275, the QAP 205 may not have any further data packets to transmit to the QSTA 210, or the QAP 205 may intend to terminate the service period. In either instance, the QAP 205 sends a null data packet 190 to the QSTA 210 to indicate an end-of-service-period (“EOSP”). The null data packet 290 may contain an EOSP indicator which may be a bit value in a control field (e.g., QoS control field) in the null data packet 290 (e.g., QoS data packet). If the channel is busy when the QAP 205 attempts to transmit the null data packet 290, the QAP 205 may perform a second backoff 285. The QSTA 210 responds to the null data packet 290 with an ACK 295. After receiving the EOSP indicator and transmitting the ACK 295 to the QAP 205, the QSTA 210 reverts to the sleep mode 225.

In the embodiment of the conventional APSD mechanism 200 shown in FIG. 2, the QSTA 210 is in the wake mode 230 for a prolonged period of time due to the backoffs 240, 270, 285 that must be performed by the QAP 205 and the QSTA 210 to access the channel. For a substantial portion of the wake mode 230, the QSTA 210 is waiting for a transmission from or waiting to transmit to the QAP 205. Thus, the QSTA 210 is consuming an increased amount of power, while inefficiently waiting to transmit/receive data packets. Furthermore, the transmission of the null data packet 290 to terminate the service period may increase system overhead and decrease bandwidth utilization.

As shown in FIG. 3, the present invention provides an enhanced scheduled APSD mechanism 300. The enhanced scheduled APSD mechanism 300 may be utilized during a contention period by the components of the system 5 shown in FIG. 1. That is, the enhanced APSD mechanism 300 is employed by a QAP 305, a QSTA 310 and/or a further QSTA 315. Accordingly, the present invention may be implemented on wireless networks such as those that support 802.11 protocols (e.g., 802.11a, 802.11b, 802.11g, 802.11e), other protocols that provide QoS and/or power-save support for multimedia applications (e.g., VoIP), and/or low-power asset tag applications (e.g., low power 802.11 RFID tags). As would be understood by those skilled in the art, the present invention may be utilized by scheduled APSD in EDCA and/or HCCA mode(s), as well as unscheduled APSD in EDCA mode.

In an exemplary embodiment of the enhanced scheduled APSD mechanism 300, the QAP 305 and the QSTA 310 agree to initiate a service period according to a predetermined time schedule (e.g., at an SST 330). At or prior to the SST 330, the QSTA 310 switches from a sleep mode 320 to a wake mode 325. As seen in FIG. 3, the channel is busy because the further QSTA 315 is transmitting a data packet 335 thereon. As would be understood by those of skill in the art, the transmission of the data packet 335, or any activity on the channel, is not a prerequisite to operation of the enhanced scheduled APSD mechanism 300. That is, the enhanced scheduled APSD mechanism 300 may be utilized whether or not the channel is busy.

According to the present invention, the QAP 305 may obtain a priority to access the channel by, for example, using a point coordination function (“PCF”) interframe spacing (“PIFS”) 340. The PIFS 340 may be used by the QAP 305 to gain access to the channel before any other QSTA, because the PIFS 340 has a shorter duration than any backoff performed by any QSTAs. That is, the PIFS 340 allows the QAP 305 to beat the other QSTAs to the channel. With the priority afforded by the PIFS 340, the QAP 305 may be the only device that may transmit on the channel. Thus, the QAP 305 transmits a buffered data packet 345 to the QSTA 310. As stated above, the buffered data packet 345 may include a plurality of buffered data packets and/or data packets that are destined for the QSTA 310.

The QSTA 310 may obtain access to the channel using a SIFS 350 before transmitting a data packet and/or an ACK to the QAP 305. The SIFS 350 may allow the QSTA 310 to access the channel before any other QSTA, because the SIFS 350 has a shorter duration than any other wait time (e.g., backoff). As noted above with regard to the conventional scheduled APSD mechanism 200, the QSTA 310 would have to perform the backoff to gain access to the channel before transmitting, thereby prolonging the time in the wake mode 325.

According to the present invention, the QAP 305 may reserve the channel for communication between only it and the QSTA 310. The QAP 305 may reserve the channel using, for example, a transmission opportunity (“TXOP”) allocation. The TXOP may be an amount of time or a number of transmissions for which the channel is reserved for communication by the QAP 305 and/or the QSTA 310. As would be understood by those skilled in the art, the QAP 305 may use the TXOP at an onset of the service period (e.g., SST 330), and/or if the ACK from the QSTA 310 shows that the data packet is waiting to be transmitted by the QSTA 310. If the QSTA 310 is not waiting to transmit the data packet, it may revert to the sleep mode 320 upon a termination condition, discussed below. In a further embodiment, the data packet and the ACK may be bundled 255, as shown in FIG. 3. That is, the data packet may be piggybacked on the ACK, which may decrease time in the wake mode 325 and lessen system overhead. Those of skill in the art would understand that each data packet-ACK combination described with regard to the present invention may be piggybacked.

The termination condition may be an event and/or condition which indicates that the service period will end or has ended, and that the QSTA 310 should switch the sleep mode 320. The termination condition may have several exemplary embodiments. In a first exemplary embodiment, the termination condition may be a predetermined agreement between the QSTA 310 and the QAP 305 that the service period will end. The predetermined agreement may reflect, for example, an expiration of a duration of the service period (e.g., 50 ms). In a further exemplary embodiment, the termination condition may be receipt of an ACK (e.g., ACK 360) with a null data field. That is, a more data field in a frame of the ACK 360 may contain a bit value (e.g., 0), which indicates that the wireless station (e.g., QAP 305) has no further data packets to transmit. Thus, upon receipt of the ACK 360, the QSTA 310 may transmit any data packets it has and/or switch to the sleep mode 320. In yet a further exemplary embodiment, the termination condition may be a data packet with the EOSP indicator set to the bit value (e.g., EOSP=one). As understood by those skilled in the art, the EOSP indicator may be contained in the data packet or a null data packet. In a further exemplary embodiment, the termination condition may represent a predetermined number of transmissions (e.g., a defined protocol). For example, the QAP 305 may transmit a first data packet to the QSTA 310, and the QSTA 310 may transmit a second data packet to the QAP 305. After this exchange, the QSTA 310 may switch to the sleep mode 320. Those of skill in the would understand that the predetermined number of transmissions encompasses any number of transmissions from the QAP 305 and/or the QSTA 310.

Yet a further exemplary embodiment of the termination condition is when the data within a data packet has a special meaning. For example, a user may be conducting a transaction (e.g., checking out inventory) which utilizes a particular application. Upon termination of the transaction, the application may generate an “end-of-transaction” data packet. Upon receipt of the “end-of-transaction” data packet, the QSTA 310 may switch to the sleep mode 320. In a further example, for a web-browsing application, the QSTA 310 may receive a data packet ending with “</body></html>” which would indicate that the QSTA should switch to the sleep mode 320. In this exemplary embodiment, the data packet may be generated by the QAP 305 if, for example, the QAP 305 and the QSTA 310 develop a private communication protocol, or a further QSTA that the QSTA 310 is communicating with to the QSTA 310.

As shown in the exemplary embodiment of the enhanced scheduled APSD mechanism 300, in response to the data packet and the ACK 355 from the QSTA 310, the QAP 305 may transmit an ACK 360 which includes a frame control field. As noted above, the frame control field includes a “more data” field. Thus, the ACK 360 may contain a bit value in the “more data” field which represents that the QAP 305 does or does not have (e.g., the termination condition) further data packets to transmit to the QSTA 310. In this manner, the QSTA 310 may revert to the sleep mode 320 upon receiving the ACK 360 without receiving a null data packet with the EOSP indicator. As noted above with respect to the exemplary embodiments of the termination condition, the QAP 305 may not transmit the null data packet if, for example, the service period is terminated upon a predetermined time and/or after transmission of a predetermined number of data packets (e.g., the defined protocol). According to the defined protocol (e.g., VoIP), the QSTA 310 may know that the QAP 305 transmits the predetermined number of data packets per service period. After receiving the predetermined number of data packets, the QSTA 310 may revert to the sleep mode 320 without having to receive the null data packet. Without requiring the null data packet, the service period has been reduced from three data packets (FIG. 2) to two data packets (FIG. 3). Reduction of data packets may improve power consumption, bandwidth utilization and reduce jitter (i.e., distortion of a signal/image caused by poor synchronization).

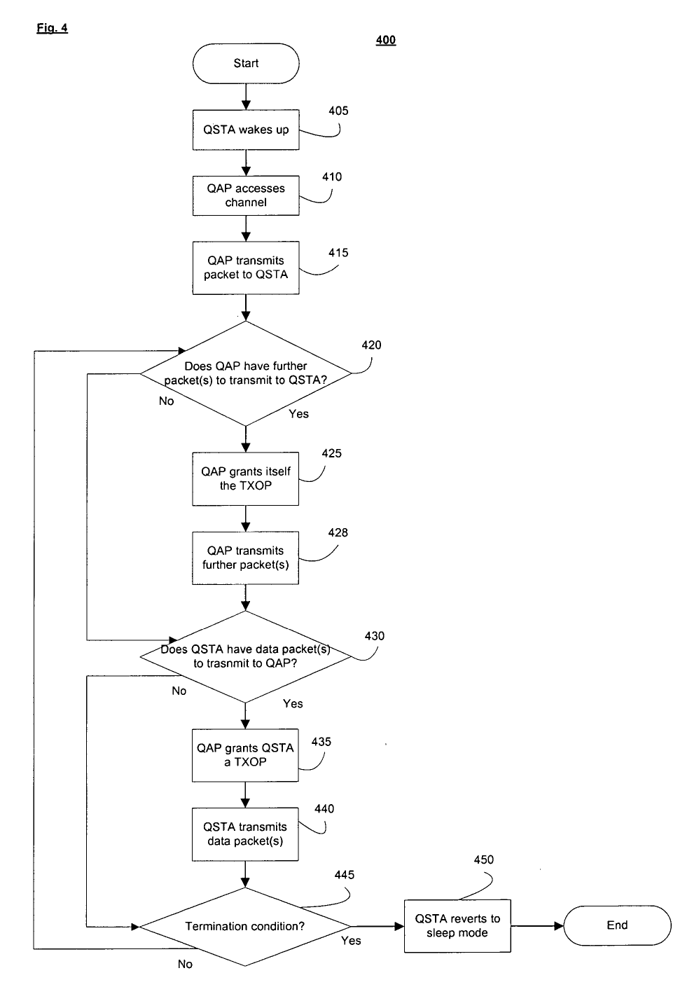

An exemplary method 400 for enhanced schedule APSD according to the present invention is shown in FIG. 4, and is described below with reference to the components of FIG. 3. In step 405, the QSTA 310 wakes up according to the predetermined time schedule (e.g., prior to or at the agreed upon SST 330).

In step 410, the QAP 305 gains access to the channel. As noted above, the QAP 305 may gain priority access to the channel by using, for example, the PIFS 340, as described above. In this manner, the QAP 305 may not be required to perform the backoff before gaining access to the channel. By gaining priority access, the QAP 305 may initiate a transmission to the QSTA 310. Thus, in a preferred embodiment, immediately at the onset of the service period (e.g., at the SST 330), the QAP 305 will gain access to the channel and transmit a packet to the QSTA 310.

In step 415, the QAP 305 transmits a packet to the QSTA 310. If the QAP 305 has the buffered data packet 345, the buffered data packet 345 is transmitted to the QSTA 310. If the QAP 305 does not have the buffered data packet 345, the QAP 305 may transmit a null data packet to the QSTA 310. Those of skill in the art would understand that receipt of the null data packet by the QSTA 310 may indicate, to the QSTA 310, that the QAP 305 does not have any buffered data packets for the QSTA 310. Utilizing the TXOP, the QAP 305 transmits the further packets to QSTA 310, as seen in step 428.

In step 420, it is determined whether the QAP 310 has a further data packet(s) to transmit to the QSTA 310. If there are no further data packets at the QAP 310, the method proceeds to step 430. If the QAP 305 has further data packets for the QSTA 310, the QAP 305 may grant itself the TXOP, as seen in step 425. As understood by those of skill in the art, the TXOP may reserve the channel for transmissions by the QAP 305. Thus, the TXOP may have a duration that is a function of, for example, a number of the further data packets.

In step 430, it is determined whether the QSTA 310 has data packet(s) to transmit. If the QSTA 310 does not have the data packet(s), the method proceeds to step 445. If the QSTA 310 has the data packet(s), the QAP 305 may grant the QSTA 310 a TXOP, as seen in step 435. As noted above, the TXOP granted to the QSTA 310 may have a duration that is a function of, for example, a number of the data packet(s) at the QSTA 310. As understood by those of skill in the art, the QAP 305 may be notified that the QSTA 310 has the data packet(s) via an indication in the ACK transmitted to the QAP 305 in response to the packet transmitted in step 415. For example, after receiving the packet from the QAP 305, the ACK from the QSTA 310 may indicate (e.g., via a bit value in a field of the ACK) that the QSTA 310 has or does not have the data packet(s). Thus, the QAP 305 may grant the QSTA 310 the TXOP based on the ACK from the QSTA 310.

In step 440, the QSTA 310 transmits the data packet to the QAP 305. In one exemplary embodiment, the data packet is transmitted as a separate transmission from the ACK sent by the QSTA 310. In a further exemplary embodiment, the data packet is piggybacked on the ACK and sent in bundle 355. In this embodiment, the ACK and/or the data packet may contain the indication that the QSTA 310 has or does not have a further data packet(s) to transmit to the QAP 310. Thus, the TXOP granted to the QSTA 310 may be a result of the ACK and/or the data packet transmitted to the QAP 305. As would be understood by those skilled in the art, steps 415 and 440, in which the QAP 305 and the QSTA 310 are transmitting packets, respectively, may allow all of the packets to be transferred before proceeding with a next respective step in the method 400.

In step 445, it is determined whether the termination condition has been reached. The exemplary embodiments of the termination condition have been discussed above. Thus, for example, when the termination condition is the predetermined number of transmissions, the QAP 305 may have transmitted a first data packet in step 415 and the QSTA 310 may have transmitted a second data packet in step 440. In this example, the predetermined number of transmissions may be one transmission each way (e.g., QAP 305 to QSTA 310 and vice-versa). After the QSTA 310 transmits the second data packet (and receives the ACK 360 from the QAP 305), the QSTA 310 may switch into the sleep mode 320, as seen in step 450. As would be understood by those skilled in the art, the method 400 may include any of the exemplary embodiments of the termination condition.

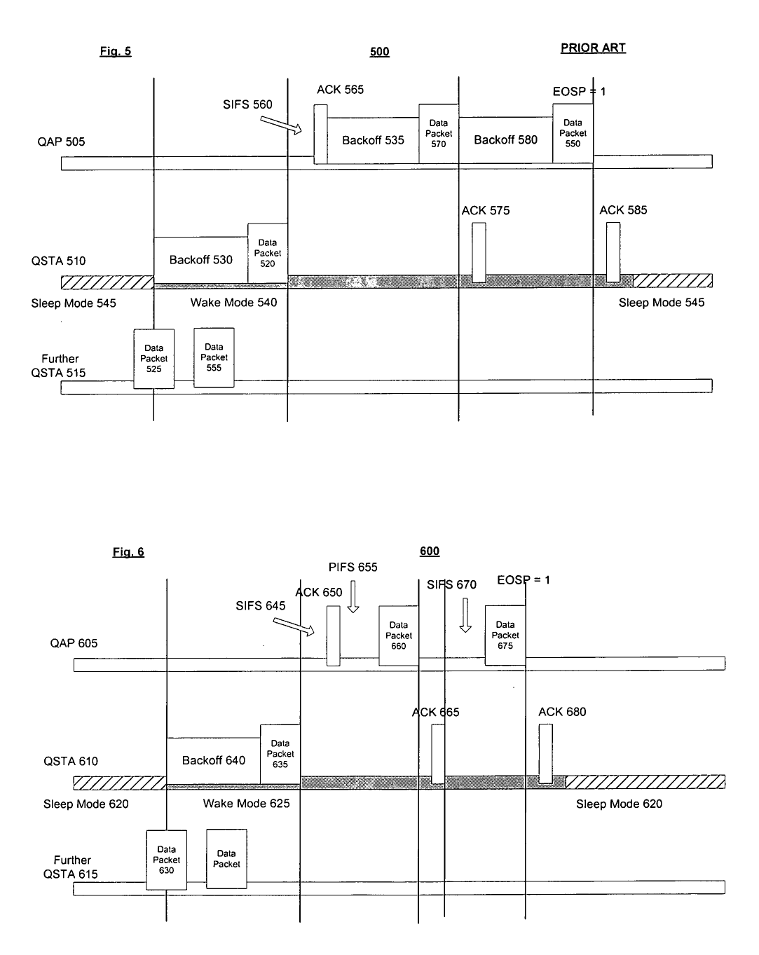

A conventional unscheduled APSD mechanism 400 is shown in FIG. 5. As understood by those skilled in the art, the conventional unscheduled APSD mechanism 400 is initiated when a QSTA 410 has a data packet 420 to send to a QAP 405. Thus, the QAP 405 and the QSTA 410 have not agreed upon a service start time, as with scheduled APSD.

As shown in FIG. 5, according to a conventional unscheduled APSD mechanism 500, a service period begins when a QSTA 510 switches to a wake mode 540, because it has a data packet 520 to transmit to a QAP 505. However, a further QSTA 515 is transmitting a data packet 525 on the channel at an onset of the service period. As such, the QSTA 510 must perform a backoff 530. During the backoff 530, the further QSTA 515, another QSTA or the QAP 505 may have transmitted a data packet 555 on the channel.

After the backoff 530 and the channel has become idle, the QSTA 510 transmits the data packet 520 to the QAP 505. Upon receipt of the data packet 520, the QAP 505 waits for a SIFS 560 and transmits an ACK 565 to the QSTA 510. If the QAP 505 is going to transmit a buffered data packet 570 to the QSTA 510, the QAP 505 must perform a backoff 535 if the channel is busy. Those skilled in the art would understand that the QAP 505 and QSTA 510 may perform backoffs for every attempted transmission (and retransmission) of a data packet if the channel is busy. As noted above, numerous backoffs may extend the service period, and, thus, a time that the QSTA 510 is in wake mode 540. Upon receipt of the buffered data packet 570, the QSTA 510 transmits an ACK 575 to the QAP 505.

After transmitting the buffered data packet 570, the QAP 505 may desire to end the service period. However, according to the conventional unscheduled APSD mechanism, the QAP 505 must transmit a data packet 550 (or a null data packet) with an EOSP indicator to inform the QSTA 510 that the service period is terminated. Thus, the QAP 505 would have to regain access to the channel, which may include performing a further backoff 580. After the QAP 505 regains access to the channel, the data packet 550 is transmitted to the QSTA 510. The EOSP indicator in the data packet 550 indicates that the service period is over, and that the QSTA 510 should switch to a sleep mode 545 after transmitting an ACK 585 to the QAP 505.

An exemplary embodiment of an enhanced unscheduled APSD mechanism 600 according to the present invention is shown in FIG. 6. A service period is initiated when a QSTA 610 has a data packet 635 to transmit to a QAP 605 and switches from a sleep mode 620 to a wake mode 625. However, as shown in FIG. 6, when the QSTA 610 enters the wake mode 625, the channel is busy because a further QSTA 615 (or the QAP 605) is transmitting a data packet 630 thereon. Thus, the QSTA 610 performs a backoff 640 prior to transmission of a data packet 635 to the QAP 605. As understood by those skilled in the art, the QSTA 610 may not have to perform the backoff 640 if the channel is idle when the QSTA 610 enters the wake mode 625.

When the channel is idle, the QSTA 610 transmits the data packet 635 to the QAP 605. Upon receipt of the data packet 635, the QAP 605 waits for a SIFS 645 and transmits an ACK 650 thereafter. The QAP 605 then uses a PIFS 655 to gain priority access to the channel. As shown in FIG. 6, the QAP 605 has a buffered data packet(s) 660 for transmission to the QSTA 610. As noted above, after gaining access to the channel using the PIFS 655, the QAP 605 may grant itself a TXOP which reserves the channel for communication by the QAP 605. In this manner, the QAP 605 transmits the buffered data packet(s) 660 to the QSTA 610, and receives an ACK 665 corresponding to each buffered data packet 660 received by the QSTA 610. As would be understood by those skilled in the art, the QAP 605 may grant the QSTA 610 the TXOP, because the data packet 635 may indicate that the QSTA 610 has further data packets to transmit to the QAP 605. The TXOP granted to the QSTA 610 may reserve the channel prior to or after transmission of the buffered data packet(s) 660 by the QAP 610.

After receiving the ACK 665, the QAP 605 may wait for a SIFS 670 before transmitting a further data packet 675. If the further data packet 675 is a last data packet for the QSTA 610, the QAP 605 may include an EOSP indicator therewith (e.g., termination condition). Thus, after receiving the further data packet 675 with the EOSP indicator, the QSTA 610 transmits an ACK 680 and switches into the sleep mode 620.

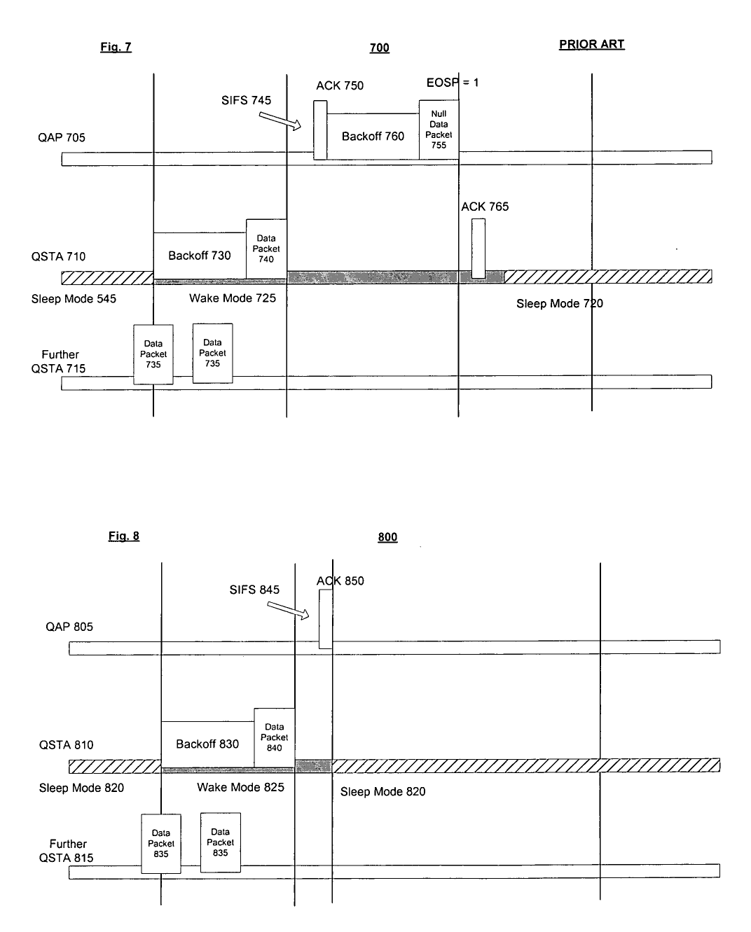

A further conventional unscheduled APSD mechanism 700 in which a QAP 705 does not have a buffered data packet(s) is shown in FIG. 7. A QSTA 710 switches from a sleep mode 720 to a wake mode 725 and accesses the channel after a backoff 730 (e.g., because a further QSTA 715 is transmitting a data packet(s) 735). After performing the backoff 730 and sensing that the channel is idle, the QSTA 710 transmits a data packet 740. Upon receipt of the data packet 740, the QAP 705 waits for a SIFS 745 and transmits an ACK 750 to the QSTA 710. In FIG. 7, the QAP 705 does not have any buffered data packets for the QSTA 710 and communicates this to the QSTA 710 using a null data packet 755. However, if the channel is busy, the QAP 705 must perform a backoff 760 before transmitting the null data packet 755. The QAP 705 can set an EOSP indicator in the null data packet 755 to indicate that the service period should be terminated. Upon receipt of the null data packet 755, the QSTA 710 transmits an ACK 765 and switches back into the sleep mode 720.

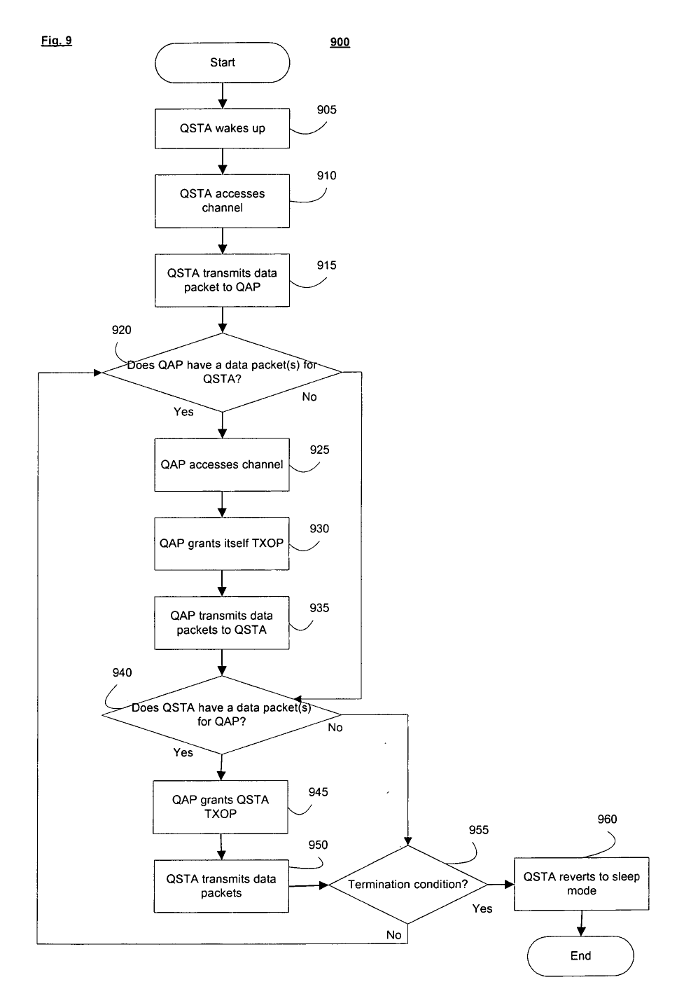

As shown in FIG. 8, a further exemplary embodiment of an enhanced unscheduled APSD mechanism 800 according to the present invention significantly reduces a time a QSTA 810 remains in a wake mode 825 and reduces system overhead presented by use of the null data packet 715 in the conventional unscheduled APSD mechanism 700. In the enhanced mechanism 800, a service period begins and the QSTA 810 switches from a sleep mode 820 into a wake mode 825 when the QSTA 810 has a data packet 840 to transmit to a QAP 805. The QSTA 810 attempts to transmit the data packet 840 to a QAP 805, but the channel is busy (e.g., a further QSTA 815 is transmitting a data packet(s) 835). After performing a backoff 830 and sensing that the channel is idle, the QSTA 810 transmits the data packet 840 to the QAP 805. As shown in FIG. 8, the QAP 805 does not have the buffered data packet(s) for the QSTA 810. If the QSTA 810 indicates (e.g., via a bit value in a frame field) that it has a further data packet(s) that may be transmitted to the QAP 805, the QAP 805 may grant the QSTA 810 a TXOP, thereby reserving the channel for the QSTA 810.

If the data packet 840 is the only transmission from the QSTA 810 (e.g., only data packet at QSTA 810), the QAP 805 may wait for a SIFS 845 and transmit an ACK 850 to the QSTA 810. As described above with reference to the exemplary embodiments of the termination condition, the ACK 850 (and the data packet 840) may include a frame control field, which may include a “more data” field. According to one exemplary embodiment of the present invention, the “more data” field may be set to a value (e.g., zero) which represents that the QAP 805 (or the QSTA 801) has no data packets (or no further data packets) to transmit. As such, upon receipt of the ACK 850, the QSTA 810 may switch from the wake mode 825 to the sleep mode 820. Thus, in one exemplary embodiment, for example, the EOSP indicator and the null data packet may be replaced by the value in the “more data” field of the ACK 850. Those of skill in the art will understand, that any of the above-described exemplary embodiments of the termination condition may be used herewith.

An exemplary method 900 for enhanced unscheduled APSD according to the present invention is shown in FIG. 9, and is described below with reference to the components of the enhanced unscheduled APSD mechanism 600 shown in FIG. 6. In step 905, the service period begins when the QSTA 610 enters the wake mode 625, because it has the data packet 635 to transmit to the QAP 605. In step 910, the QSTA 610 accesses the channel. As noted above, if the channel is busy, the QSTA 610 may have to perform the backoff 640 and wait until the channel is idle before transmitting. In step 915, the QSTA 610 transmits the data packet 635 to the QAP 605.

In step 920, it is determined whether the QAP 605 has the buffered data packet 660 for transmission to the QSTA 610. If the QAP 605 does not have the buffered data packet 660, the method proceeds to step 940. If the QAP 605 has the buffered data packet 660, the QAP 605 may use the PIFS 655 to gain priority access to the channel, as seen in step 925. In step 930, the QAP 605 grants itself a TXOP, and, in step 935, the QAP 605 transmits the buffered data packet 660 to the QSTA 610. While the QAP 605 has the channel reserved, it may transmit the further data packet 675 to the QSTA 610.

In step 940, it is determined whether the QSTA 610 has a further data packet(s) to transmit. If the QSTA 610 does not have a further data packet(s), the method proceeds to step 955. If the QSTA 610 does have the further data packet(s) to transmit, the QAP 605 may grant the TXOP to the QSTA 610, as seen in step 945. As described above, the data packet 635 and/or the ACK 665 may indicate that to the QAP 605 that the QSTA 610 contains the further data packets for transmission. In step 950, the QSTA 610 transmits the further data packet(s).

In step 955, the termination condition is reached. As understood by those skilled in the art, the QAP 605 and the QSTA 610 may transmit data packets back and forth until the termination condition is reached. As described herein, the termination condition may be any one, or combination of, the exemplary embodiments described above. After the termination condition has been reached, the QSTA 610 switches from the wake mode 625 to the sleep mode 620, as seen in step 960. As understood by those skilled in the art, prior to switching to sleep mode 620, the QSTA 610 may transmit the ACK 680 to the QAP 605.

The present invention has been described with the reference to the QAP, the QSTA and the termination condition. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method for wireless communication, comprising:
(a) switching, according to a predetermined time schedule, a wireless station from a first communications mode into a second communications mode, the station capable of at least one of receiving and transmitting data packets only when the station is in the second mode, the first mode being a power conservation mode;
(b) when the station is in the second mode, obtaining, by a wireless access point, a priority access to a radio channel;
(c) after step (b), reserving, by the access point, the radio channel for wireless communications between the access point and the station;
(d) conducting wireless communications between the access point and the station over the radio channel; and
(e) upon a termination condition, switching the station into the first mode.

2. The method according to claim 1, wherein the termination condition is one of (a) a data packet with an end-of-service-period (EOSP) indicator, (b) a null data packet with the EOSP indicator, (c) an ack packet with a null data field, (d) expiration of a predetermined time and (e) transfer of a predetermined number of data packets between the station and the access point.

3. The method according to claim 1, wherein the priority access to the radio channel is obtained when the access point utilizes a PIFS.

4. The method according to claim 1, wherein the reserving step includes the following substep:
granting a transmission opportunity to one of the access point and the station.

5. The method according to claim 4, wherein the transmission opportunity comprises a time period in which one of the access point and the station is transmitting a set of data packets over the radio channel.

6. The method according to claim 5, wherein the time period is determined as a function of a number of data packets in the set of data packets.

7. The method according to claim 5, wherein the time period is represented in a duration field of a data packet transmitted by the access point.

8. The method according to claim 1, wherein the steps (a)-(e) are performed during a contention period.

9. A method for wireless communication, comprising:
(a) when a wireless station has a first data packet addressed for a wireless access point, switching the station from a first communications mode to a second communications mode, the station capable of at least one of receiving and transmitting data packets only when the station is in the second mode, the first mode being a power conservation mode;
(b) when a radio channel is available to the station, transmitting to the access point the first data packet by the station using the radio channel;
(c) receiving the first data packet by the access point;
(c) transmitting by the access point an ack packet to the station, the ack packet being indicative of receipt by the access point of the first data packet and one of (1) existence and (2) nonexistence of a second data packet addressed for the station;
(d) if one of (1) the ack packet indicates the existence of the second data packet and (2) the station has a further data packet addressed for the access point, performing the following substeps:
(i) obtaining, by the access point, a priority access to the radio channel;
(ii) after substep (i), reserving, by the access point, the radio channel for wireless communications between the access point and the station; and
(iii) conducting wireless communications between the access point and the station over the radio channel; and
(e) upon a termination condition, switching the station into the first mode.

10. The method according to claim 9, wherein when the ack packet indicates the nonexistence of the second data packet, the ack packet includes a null data field.

11. The method according to claim 10, wherein the termination condition is one of (a) a data packet with an end-of-service-period indicator, (b) the ack packet with the null data field, (c) expiration of a predetermined time and (d) transfer of a predetermined number of data packets between the station and the access point.

12. The method according to claim 9, wherein the priority access to the radio channel is obtained when the access point utilizes a PIFS.

13. The method according to claim 9, wherein the reserving substep includes the following substep:
granting a transmission opportunity to one of (1) the access point and (2) the station.

14. The method according to claim 13, wherein the transmission opportunity comprises a time period in which one of the access point and the station is transmitting a set of data packets over the radio channel.

15. The method according to claim 14, wherein the time period is determined as a function of a number of data packets in the set of data packets.

16. The method according to claim 14, wherein the time period is represented in a duration field of a data packet transmitted by the access point.

17. The method according to claim 9, wherein the steps (a)-(e) are performed during a contention period.

18. A system, comprising:
a wireless station; and
a wireless access point in communication with the station,
wherein, the station switches, according to a predetermined time schedule, from a first communications mode into a second communications mode, the station capable of at least one of receiving and transmitting data packets only when the station is in the second mode, the first mode being a power conservation mode,
wherein when the station is in the second mode, the access point obtains a priority access to a radio channel,
wherein the access point reserves the radio channel for wireless communications between the access point and the station,
wherein wireless communications are conducted between the access point and the station over the radio channel, and
wherein upon a termination condition, the station switches into the first mode.

19. A system, comprising:
a wireless station; and
a wireless access point in communication with the station,
wherein, the wireless station switches from a first communications mode to a second communications mode when the station has a first data packet addressed for the access point, the station capable of at least one of receiving and transmitting data packets only when the station is in the second mode, the first mode being a power conservation mode,
wherein when a radio channel is available to the station, the station transmits to the access point the first data packet using the radio channel,
wherein the access point receives the first data and transmits an ack packet to the station, the ack packet being indicative of receipt by the access point of the first data packet and one of (1) existence and (2) nonexistence of a second data packet addressed for the station,
wherein if one of (1) the ack packet indicates the existence of the second data packet and (2) the station has a further data packet addressed for the access point, then (i) the access point obtains a priority access to the radio channel and (ii) reserves the radio channel for wireless communications between the access point and the station and wireless communications are conducted between the access point and the station over the radio channel, and
wherein, upon a termination condition, the station switches into the first mode.
